(19) United States
(12) Patent Application Publication
(10) Pub. No.: US 2025/0171986 A1
(43) Pub. Date: May 29, 2025

(54) WATERWAY SWITCHING ASSEMBLY, TOILET WATER SUPPLY DEVICE, AND FLUSHING METHOD FOR THE TOILET WATER SUPPLY DEVICE

(71) Applicant: Kohler (China) Investment Co., Ltd., Shanghai (CN)

(72) Inventor: Junfeng Sun, Shanghai (CN)

(21) Appl. No.: 18/946,072

(22) Filed: Nov. 13, 2024

(30) Foreign Application Priority Data
Nov. 28, 2023 (CN) 202311609855.X
Nov. 28, 2023 (CN) 202323229383.3

(51) Int. Cl. E03C 1/04; F16K 11/00

(52) U.S. Cl. CPC E03C 1/04; F16K 19/00; E03C 2201/30

(57) ABSTRACT

A waterway switching assembly includes a control pipe including a first control end; a second control end; and a side opening disposed between the first control end and the second control end. The waterway switching assembly further includes a valve core disposed in the control pipe and configured to move between the first control end and the second control end. The waterway switching assembly further includes a first outlet pipe in fluid communication with the first control end. The waterway switching assembly further includes a second outlet pipe in fluid communication with the second control end.

### CROSS REFERENCE TO RELATED APPLICATION

This application claims the benefit of priority to: Chinese Patent Application No. 202311609855.X filed in the Chinese Intellectual Property Office on Nov. 28, 2023, which is hereby incorporated by reference in its entirety; Chinese Patent Application No. 202323229383.3 filed in the Chinese Intellectual Property Office on Nov. 28, 2023, which is hereby incorporated by reference in its entirety.

### FIELD

The application relates to the technical field of sanitary ware and more particularly relates to a waterway switching assembly, a toilet water supply device, and a flushing method for the toilet water supply device.

### BACKGROUND

Toilets are becoming increasingly popular in home and commercial areas due to their convenience and comfort. Traditional toilets are larger in size and occupy more space and cannot be well adapted to the current small bathroom for household or commercial use.

Currently, a toilet flushing method uses a pressure water source to flush the toilet. The pressure water source is distributed to a bowl outlet or a siphon port through a switching valve driven by a stepping motor. Flushing controlled by the switching valve requires a motor switching valve and a motor controller. This increases the cost and complexity in system design. In addition, the above-mentioned electrical elements need to be moisture-proof and thus need to be disposed outside the water tank. Thus, the design space is wasted.

### SUMMARY

The present disclosure aims to provide a waterway switching assembly, a toilet water supply device, and a flushing method of the toilet water supply device, which may enhance the flushing effect, may reduce the cost, may simplify the design, and may save the space.

The present disclosure provides a waterway switching assembly including a control pipe, an inlet pipe, a first outlet pipe, and a second outlet pipe. The inlet pipe, the first outlet pipe, and the second outlet pipe are in communication with (e.g., in fluid communication with) the control pipe. The waterway switching assembly also includes a control member (e.g., a controller). The control pipe includes a first control end and a second control end arranged in a length direction and includes a side opening provided between the first control end and the second control end. The control pipe is internally provided with a valve core configured to move between the first control end and the second control end. When the valve core is moved to the first control end, the valve core and the first control end are located on the same side (e.g., a first side) of the side opening. When the valve core is moved to the second control end, the valve core and the second control end are located on the same side (e.g., a second side) of the side opening. The first outlet pipe is in communication with (e.g., in fluid communication with) the first control end. The first outlet pipe includes a first outlet so that the valve core is moved to the first control end under the inertial force of water flowing in the first outlet pipe after a first water supply from the inlet pipe to the control pipe is completed, during a single waterway switching process. The second outlet pipe is in communication with (e.g., in fluid communication with) the second control end. The control member is configured to control the water supply time and water supply stopping interval of the water flowing from the inlet pipe into the control pipe to control water discharging from the first outlet pipe and the second outlet pipe.

In an embodiment, the first control end is located above the second control end.

In an embodiment, the water supply time includes a first water supply time and a second water supply time, and the water supply stopping interval includes a first water supply stopping interval. The inlet pipe supplies water to the control pipe for the first time according to the first water supply time, and the valve core is limited at the second control end under water pressure, to cause the first outlet of the first outlet pipe to spray water. When the inlet pipe stops supplying water for the first time, the valve core is pulled upward and moved to the first control end by the inertial pulling force of water flowing in the first outlet pipe, and the height of the first outlet is lower than the height of the first control end, so as to make the valve core attached and maintained in the first control end under the gravitational force of water flowing in the first outlet pipe. The inlet pipe starts supplying water to the control pipe for the second time according to the second water supply time at the first water supply stopping interval, to limit the valve core at the first control end by water pressure before the valve core falls, and the second outlet pipe discharges water. After the inlet pipe stops the second water supply, the valve core is moved to the second control end.

In an embodiment, the water supply time includes a third water supply time, and the water supply stopping interval also includes a second water supply stopping interval. The inlet pipe starts supplying water to the control pipe for the third time according to the third water supply time at the second water supply stopping interval. After the inlet pipe stops the third water supply, the valve core is limited at the second control end to restore the initial state.

In an embodiment, the first control end is provided with a first step for limiting the valve core, and the second control end is provided with a second step for limiting the valve core.

In an embodiment, there is a clearance (e.g., a gap) between the valve core and the second step.

In an embodiment, a clearance (e.g., a gap) between the valve core and an inner wall of the control pipe is L, wherein 0.1 mm≤L≤2 mm.

In an embodiment, the inlet pipe is internally provided with a one-way control member for the water flowing from the inlet pipe into the control pipe in a single direction.

In an embodiment, one end of the inlet pipe is provided with a connecting bend, the connecting bend is connected to the side opening, the connecting bend is either substantially horizontal or tilted downward in a direction toward the side opening, and the one-way control member is provided inside the connecting bend.

The present disclosure also provides a toilet water supply device including a waterway switching assembly and a toilet body. The toilet body includes a bowl, a washing outlet configured to supply water to the bowl, and a siphon outlet. The waterway switching assembly includes a control pipe, an inlet pipe, a first outlet pipe, and a second outlet pipe. The inlet pipe, the first outlet pipe, and the second outlet pipe are in communication with (e.g., in fluid communication with) the control pipe. The waterway switching assembly also includes a control member. The control pipe includes a first control end and a second control end arranged in a length direction and includes a side opening provided between the first control end and the second control end. The control pipe is internally provided with a valve core configured to move between the first control end and the second control end. When the valve core is moved to the first control end, the valve core and the first control end are located on the same side of the side opening. When the valve core is moved to the second control end, the valve core and the second control end are located on the same side of the side opening. The inlet pipe is in communication with and between the side opening and a source of flushing water. The first outlet pipe is in communication between the first control end and the washing outlet. The first outlet pipe includes a first outlet so that the valve core is moved to the first control end under the inertial force of water flowing in the first outlet pipe after a first water supply from the inlet pipe to the control pipe is completed, during a single water flushing process. The second outlet pipe is in communication with and between the second control end and the siphon outlet. The control member (e.g., the controller) is configured to control the water supply time and water supply stopping interval of the water flowing from the inlet pipe into the control pipe to cause flushing water to flush the bowl.

In an embodiment, the first control end is located above the second control end.

In an embodiment, the water supply time includes a first water supply time and a second water supply time, and the water supply stopping interval includes a first water supply stopping interval. The inlet pipe supplies water to the control pipe for the first time according to the first water supply time, and the valve core is limited at the second control end under water pressure, such that water is sprayed from the first outlet of the first outlet pipe to flush the bowl with water. When the inlet pipe stops supplying water for the first time, the valve core is pulled upward and moved to the first control end by the inertial pulling force of water flowing in the first outlet pipe, and the height of the first outlet is lower than the height of the first control end, so as to make the valve core attached and maintained in the first control end under the gravitational force of water flowing in the first outlet pipe. The inlet pipe starts supplying water to the control pipe for the second time according to the second water supply time after the first water supply stopping interval, to limit the valve core at the first control end by water pressure before the valve core falls, and the second outlet pipe discharges water to cause siphon drainage at the siphon outlet. After the inlet pipe stops the second water supply, the valve core is moved to the second control end.

In an embodiment, the water supply time includes a third water supply time, and the water supply stopping interval also includes a second water supply stopping interval. The inlet pipe starts supplying water to the control pipe for the third time according to the third water supply time after the second water supply stopping interval, to wash the bowl and form a water seal in the bowl. After the inlet pipe stops the third water supply, the valve core is limited at the second control end to restore the initial state.

In an embodiment, the first control end is provided with a first step for limiting the valve core, and the second control end is provided with a second step for limiting the valve core.

In an embodiment, there is a clearance (e.g., a gap) between the valve core and the second step.

In an embodiment, the clearance between the valve core and an inner wall of the control pipe is L, wherein 0.1 mm≤L≤2 mm.

In an embodiment, the inlet pipe is internally provided with a one-way control member for water flowing from the inlet pipe into the control pipe in a single direction.

In an embodiment, one end of the inlet pipe is provided with a connecting bend, the connecting bend is connected to the side opening, the connecting bend is either substantially horizontal or tilted downward in a direction toward the side opening, and the one-way control member is provided inside the connecting bend.

In an embodiment, the flushing water is located inside a water tank, a water pump is provided in the water tank, and the controller is communicably connected to the water pump to control the water supply time and the water supply stopping interval by controlling on-and-off of the water pump. Alternatively, the flushing water is a pressurized water, a control switch is provided on the inlet pipe or on a water supply component for the pressurized water, and the control member is communicably connected to the control switch to control the water supply time and the water supply stopping interval by controlling on-and-off of the controller switch.

The present disclosure also provides a flushing method for controlling a toilet water supply device as described above to flush water. The method includes: controlling, by the control member, water supply time and water supply stopping interval of the water flowing from the inlet pipe into the control pipe so as to drive the valve core to move between the first control end and the second control end of the control pipe to flush the toilet body.

In an embodiment, the method also includes disposing the first control end above the second control end, setting the water supply time to include a first water supply time and a second water supply time, and setting the water supply stopping interval to include a first water supply stopping interval. The method also includes controlling, by the control member (e.g., the controller), the inlet pipe to supply water to the control pipe for the first time according to the first water supply time and limiting the valve core at the second control end under water pressure to cause flushing water to pass through the inlet pipe, the control pipe, the first outlet pipe and flow out from the washing outlet of the toilet body to clean the bowl of the toilet body. The method also includes controlling, by the control member, the inlet pipe to stop supplying water for the first time and pulling the valve core upward to abut against the first control end by the inertial pulling force of water flowing in the first outlet pipe. The method also includes controlling, by the control member, the inlet pipe to supply water to the control pipe for the second time according to the second water supply time after stopping water supply according to the first water supply stopping interval, to press upward and limit the valve core at the first control end by water pressure before the valve core falls. The method also includes discharging, by the second outlet pipe, water to cause siphon drainage at the siphon outlet of the toilet body. The method also includes controlling, by the control member, the inlet pipe to stop the second water supply and moving the valve core is moved to the second control end under the inertial force of the water flowing in the second outlet pipe and its own gravitational force.

In an embodiment, the method also includes setting the water supply time to include a third water supply time and setting the water supply stopping interval to include a second water supply stopping interval. The method also includes controlling, by the control member, the inlet pipe to supply water to the control pipe for the third time according to the third water supply time after stopping water supply according to the second water supply stopping interval, to wash the bowl and form a water seal in the bowl. The method also includes controlling, by the control member, the inlet pipe to stop supplying water for the third time and limiting the valve core at the second control end to restore the initial state.

By adopting the technical solutions above, the present disclosure has the following beneficial effects:

The waterway switching assembly, toilet water supply device, and a flushing method of the toilet water supply device provided by the present disclosure can achieve alternate water discharge between the first water outlet pipe connected to the washing outlet and the second outlet pipe connected to the siphon outlet, by controlling the water supply time and water supply stopping interval of the water flowing in the inlet pipe into the control pipe. Thus, one flushing of the toilet body may be achieved. The above-mentioned flushing process is controlled by the waterway switching assembly, and there is no need to arrange additional components, such as a motor switching valve and a motor control member to control flushing. This may enhance the flushing effect, may reduce the cost, may simplify the design, and may save the space.

### BRIEF DESCRIPTION OF THE FIGURES

FIG. 1 is a structural schematic view of the waterway switching assembly according to an embodiment of the present disclosure;

FIG. 2 is a partially enlarged view of Part A of FIG. 1;

FIG. 3 is a structural schematic view of the inlet pipe when the water is supplied for the first time according to an embodiment of the present disclosure;

FIG. 4 is a structural schematic view of the valve core being pulled upward and limited at the first control end after the first water supply from the inlet pipe according to an embodiment of the present disclosure;

FIG. 5 is a structural schematic view of the valve core being limited at the first control end when the water is supplied from the inlet pipe for the second time according to an embodiment of the present disclosure;

FIG. 6 is a structural schematic diagram of the valve core being moved to the second control end under the inertia force of the water flowing in the second outlet pipe and its own gravitational force after the second water supply from the inlet pipe according to an embodiment of the present disclosure;

FIG. 7 is a structural schematic view of the inlet pipe when the water is supplied for the third time according to an embodiment of the present disclosure;

FIG. 8 is a structural schematic view of the air entering into a first outlet pipe after the third water supply from the inlet pipe according to an embodiment of the present disclosure;

FIG. 9 is a structural schematic view of the valve core falling back to the initial state under its own action after the third water supply from the inlet pipe according to an embodiment of the present disclosure;

FIG. 10 is a structural schematic view of a toilet water supply device according to an embodiment of the present disclosure;

FIG. 11 is a top view of the toilet water supply device according to an embodiment of the present disclosure;

FIG. 12 is a sectional view of B-B in FIG. 11;

FIG. 13 is a structural schematic view of the waterway switching assembly provided in a water tank according to an embodiment of the present disclosure;

FIG. 14 is a structural schematic view of a toilet water supply device in an initial state according to an embodiment of the present disclosure;

FIG. 15 is a longitudinal sectional view of a toilet water supply device when water is supplied from an inlet pipe for the first time according to an embodiment of the present disclosure;

FIG. 16 is a longitudinal sectional view of a toilet water supply device immediately after water is supplied from an inlet pipe for the first time according to an embodiment of the present disclosure;

FIG. 17 is a structural schematic view of the air entering into a first outlet pipe after the first water supply from the inlet pipe according to an embodiment of the present disclosure;

FIG. 18 is a longitudinal sectional view of a toilet water supply device when water is supplied from the inlet pipe for the second time according to an embodiment of the present disclosure;

FIG. 19 is a structural schematic view of the toilet water supply device after the second water supply from the inlet pipe according to an embodiment of the present disclosure;

FIG. 20 is a longitudinal sectional view of a toilet water supply device when water is supplied from an inlet pipe for the third time according to an embodiment of the present disclosure;

FIG. 21 is a longitudinal sectional view of a toilet water supply device after water is supplied from the inlet pipe for the third time according to an embodiment of the present disclosure;

FIG. 22 is a longitudinal sectional view of the toilet water supply device after the third water supply from the inlet pipe has ended for a certain period of time according to an embodiment of the present disclosure;

FIG. 23 is a first flowchart of a flushing method of the toilet water supply device according to an embodiment of the present disclosure;

FIG. 24 is a second flowchart of a flushing method of the toilet water supply device according to an embodiment of the present disclosure;

FIG. 25 is a third flowchart of a flushing method of the toilet water supply device according to an embodiment of the present disclosure;

FIG. 26 is a block diagram of a controller of the toilet water supply device according to an embodiment of the present disclosure; and

FIG. 27 is a block diagram of the toilet water supply device comprising the controller according to an embodiment of the present disclosure.

### REFERENCE NUMERALS

100—Waterway switching assembly, 600—Toilet water supply device;
1—Control pipe, 10—First control end, 11—Second control end, 12—Side opening, 13—First step, 14—Second step;
2—Valve core;
3—Inlet pipe, 30—One-way control member, 31—Connecting bend;
4—First outlet pipe, 40—First outlet;
5—Second outlet pipe;
6—Toilet body, 60—Bowl, 61—Washing outlet, 62—Siphon outlet;
7—Water tank;
8—Water pump;
9—Air.

### DETAILED DESCRIPTION

The embodiments of the present disclosure are further described with reference to the drawings hereinafter.

It should be readily understood that, according to the present disclosure, a plurality of structural modes as well as implementation methods are interchangeable by those having ordinary skill in the art without changing the substantial spirit of the present disclosure. Therefore, the following embodiments as well as the accompanying drawings are only intended to illustrate the technical solutions of the present disclosure. The embodiments and the drawings should not be regarded as the entire present disclosure or a limitation or restriction to the technical solutions of the present disclosure.

The orientational terms, such as “up”, “down”, “left”, “right”, “front”, “rear”, “back”, “upper”, “bottom”, etc., which are mentioned or may be mentioned in the present disclosure, refer to the directions shown in the accompanying drawings. The terms are relative concepts and thus may be changed based on the different positions of the elements and different usage states. Therefore, these or other orientational terms should also not be interpreted as restrictive terms.

The present disclosure provides a waterway switching assembly 100 comprising a control pipe 1, an inlet pipe 3, a first outlet pipe 4, and a second outlet pipe 5. The inlet pipe 3, the first outlet pipe 4, and the second outlet pipe 5 are in communication with (e.g., in fluid communication with) the control pipe 1. The waterway switching assembly 100 also comprises a control member (e.g., a controller 200 as described below).

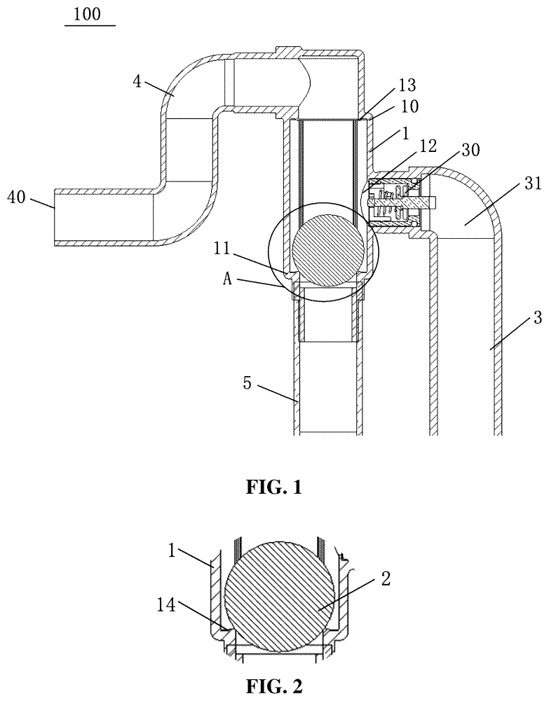

As shown in FIG. 1, the control pipe 1 comprises a first control end 10 and a second control end 11, which are arranged in a length direction of the control pipe 1. The control pipe 1 also comprises a side opening 12 provided between the first control end 10 and the second control end 11. The control pipe 1 is internally provided with a valve core 2 configured to move between the first control end 10 and the second control end 11. In an embodiment, the waterway switching assembly 100 may be in “h” shape or “n” shape.

When the valve core 2 is moved to the first control end 10, the valve core 2 and the first control end 10 are located on the same side (e.g., a first side) of the side opening 12. When the valve core 2 is moved to the second control end 11, the valve core 2 and the second control end 11 are located on the same side (e.g., a second side) of the side opening 12.

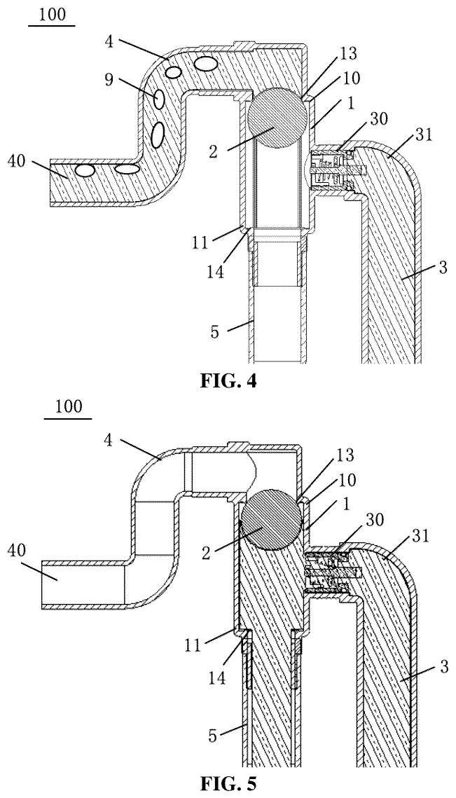

Referring to FIGS. 4 and 5, the valve core 2 and the first control end 10 are located on the same side of the side opening 12. This means that when the valve core 2 is moved to the first control end 10, the entire valve core 2 is located on a side, adjacent to an inner wall of the first control end 10, of the side opening 12, or a portion of the valve core 2 is located between the inner walls of the side opening 12. This configuration may meet the requirement that the water pressure keeps the valve core 2 abutting against the first control end 10 when the side opening 12 supplies water to the control pipe 1.

Referring to FIGS. 1, 3, 6, 7, 8, and 9, the valve core 2 and the second control end 11 are located on the same side of the side opening 12. This means that when the valve core 2 is moved to the second control end 11, the entire valve core 2 is located on a side, adjacent to an inner wall of the second control end 11, of the side opening 12, or a portion of the valve core 2 is located between the inner walls of the side opening 12. This configuration may meet the requirement that the valve core 2 is kept abutting against the second control end 11 when the side opening 12 supplies water to the control pipe 1.

The first outlet pipe 4 is in communication with the first control end 10, and the first outlet pipe 4 comprises a first outlet 40. According to an embodiment, in an initial state, the valve core 2 is located on the same side of the side opening 12 as the second control end 11. During a single waterway switching process, and after a first water supply from the inlet pipe 3 to the control pipe 1 is completed, the valve core 2 is moved to the first control end 10 under the inertial force of water flowing in the first outlet pipe 4. In a single waterway switching process, at the moment when the water supply from the inlet pipe 3 to the control pipe 1 is stopped for the first time (i.e., the first water supply from the inlet pipe 3 to the control pipe 1 is stopped), the water flowing in the first outlet 40 of the first outlet pipe 4 pulls the valve core 2 by the inertial force, and the valve core 2 is moved to the first control end 10 under the pulling action of the inertial force, as shown in FIG. 4. The first outlet pipe 4 is a U-shaped pipe, and the first outlet 40 and an opening, connecting the control pipe 1, of the first outlet pipe 4 are two ends of the U-shaped pipe. The second outlet pipe 5 is in communication with the second control end 11, as shown in FIGS. 1-9.

The control member is configured to control the water supply time and water supply stopping interval of the water flowing from the inlet pipe 3 into the control pipe 1 to control the water from the first outlet pipe 4 and the second outlet pipe 5 and thus to achieve alternative water supply for bathroom fixtures, such as achieving toilet flushing. The control member according to the embodiment of the present disclosure may include a water flow switch configured to control the water supply time and water supply stopping interval of the water flowing from the inlet pipe into the control pipe. The control member according to the embodiment of the present disclosure may include a control equipment (e.g., a controller 200 as described below) with preset water supply time and water supply stopping interval and configured to control the inlet pipe 3 to supply the water according to the preset water supply time and water supply stopping interval.

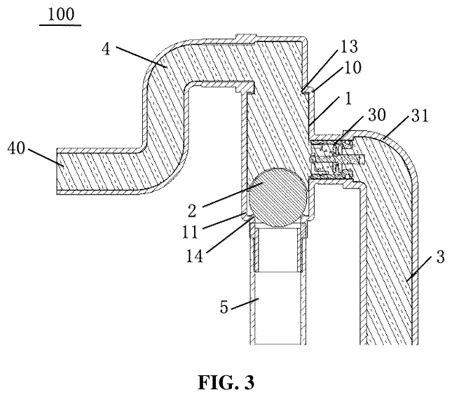

The single waterway switching process by the waterway switching assembly 100 is described below. According to an embodiment, in an initial state, the valve core 2 is located on the same side of the side opening 12 as the second control end 11. The control member controls the inlet pipe 3 to supply water to the control pipe 1 for the first time (the “first water supply”) according to the water supply time, as shown in FIG. 3, in order to make water come out from the first outlet 40 of the first outlet pipe 4. At the moment when the inlet pipe 3 stops supplying water for the first time (i.e., stops the first water supply), the valve core 2 is pulled upward and abuts against the first control end 10 by the inertial pulling force of the water flowing in the first outlet pipe 4, as shown in FIG. 4. The inlet pipe 3 starts supplying water to the control pipe 1 for the second time (the “second water supply”) according to the water supply time after a water supply stopping interval, to limit the valve core 2 at the first control end 10 by water pressure before the valve core 2 leaves the first control end 10, so as to cause the second outlet pipe 5 to discharge water, as shown in FIG. 5. After the inlet pipe 3 stops supplying water for the second time (i.e., stops the second water supply), the valve core 2 is moved to abut the second control end 11 under the inertial force of the water flowing in the second outlet pipe 5, as shown in FIG. 6.

The waterway switching assembly 100 according to the present disclosure, by controlling the water supply time and water supply stopping interval of the water flowing in the inlet pipe 3 into the control pipe 1, achieves the alternative water discharge between the first outlet pipe 4 and the second outlet pipe 5, so as to achieve a single waterway switching. The above-mentioned waterway switching process is completed by controlling the waterway switching assembly 100, and there is no need to arrange additional components, such as a motor switching valve and a motor control member to control flushing. This may enhance the waterway switching effect, may reduce the cost, may simplify the design, and may save the space.

In an embodiment, the first control end 10 is located above the second control end 11. As shown in FIG. 1, in this embodiment, in the initial state, the valve core 2 abuts against the second control end 11 under the action of water pressure. In a single waterway switching process, at the moment when the water supply from the inlet pipe 3 to the control pipe 1 is stopped for the first time, the water flowing in the first outlet 40 of the first outlet pipe 4 pulls the valve core 2 upward by the inertial force, and the valve core 2 overcomes its own gravitational force and is moved to the first control end 10 under the upward pulling of the inertial force, as shown in FIG. 4. The inlet pipe 3 starts supplying water to the control pipe 1 for the second time after a water supply stopping interval, to limit the valve core 2 at the first control end 10 by water pressure before the valve core 2 falls, so as to cause the second outlet pipe 5 to discharge water, as shown in FIG. 5. After the inlet pipe 3 stops the second water supply, the valve core 2 is moved to and abuts against the second control end 11, as shown in FIG. 6. When the water supply is stopped for the third time, the valve core 2 is maintained abutting against the second control end 11 by its own gravitational force, as shown in FIG. 9.

In an embodiment, the water supply time comprises a first water supply time and a second water supply time, and the water supply stopping interval comprises a first water supply stopping interval. The inlet pipe 3 supplies, according to the first water supply time, water to the control pipe 1 for the first time, and the valve core 2 is limited at the second control end 11 under water pressure, so as to cause water to spray from the first outlet 40 of the first outlet pipe 4. When the inlet pipe 3 stops supplying water for the first time, the valve core 2 is pulled and moved to the first control end 10 by the inertial pulling force of water flowing in the first outlet pipe 4, and the height of the first outlet 40 is lower than the height of the first control end 10, so as to make the valve core 2 attached and adsorbed to the first control end 10 under the gravitational force of water flowing in the first outlet pipe 4. In a single shower water discharge cycle, at the moment when the water supply from the inlet pipe 3 to the control pipe 1 is stopped for the first time, the water flowing in the first outlet 40 of the first outlet pipe 4 pulls the valve core 2 toward the position of the first control end 10 by the inertial force, and the valve core 2 overcomes its own gravitational force and is moved to the first control end 10 under the action of pulling of the inertial force. Because the height of the first outlet 40 is lower than the height of the valve core 2, the inverted U-shaped structure of the first outlet pipe 4 converts the gravitational force of the water into the suction force acting on the valve core 2, so that the valve core 2 is maintained in a position in which the valve core 2 abuts against the first control end 10, as shown in FIG. 4.

The inlet pipe 3 starts supplying water to the control pipe 1 for the second time according to the second water supply time after the first water supply stopping interval, to limit the valve core 2 at the first control end 10 by water pressure before the valve core 2 falls, and the second outlet pipe 5 discharges water, as shown in FIG. 5. After the inlet pipe 3 stops the second water supply, the valve core 2 is moved to the second control end 11, as shown in FIG. 6. Specifically, at the moment when the water supply from the inlet pipe 3 to the control pipe 1 is stopped for the second time, the water flowing in the second outlet pipe 5 pulls the valve core 2 and limits the valve core 2 at the second control end 11 by the inertial force. The outlet of the second outlet pipe 5 is lower than the valve core 2. This configuration converts the gravitational force of the water into a suction force acting on the valve core 2 and maintains the valve core 2 in an unchanged position together with the gravitational force of the valve core 2. At the same time, the air 9 gradually enters from a side of the first outlet pipe 4, and the air 9 breaks the inertial force, acting on the valve core 2, of the water in the second outlet pipe 5. The second water supply time in this embodiment may be 4 s, or the second water supply time may be selected between 2 s to 10 s to achieve a water discharging effect of the second outlet pipe 5. The first water supply stopping interval may be 0.5 s or may be selected between 0.1 s to 1.0 s, to start the second water supply before the valve core 2 falls resulting from the air 9 gradually entering from the first outlet 40 and destroying the suction of the inertial force, acting on the valve core 2, of the [symbol] .

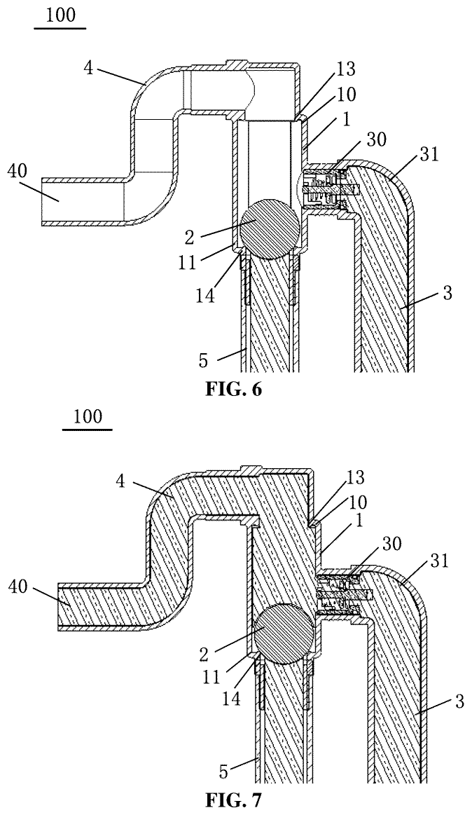

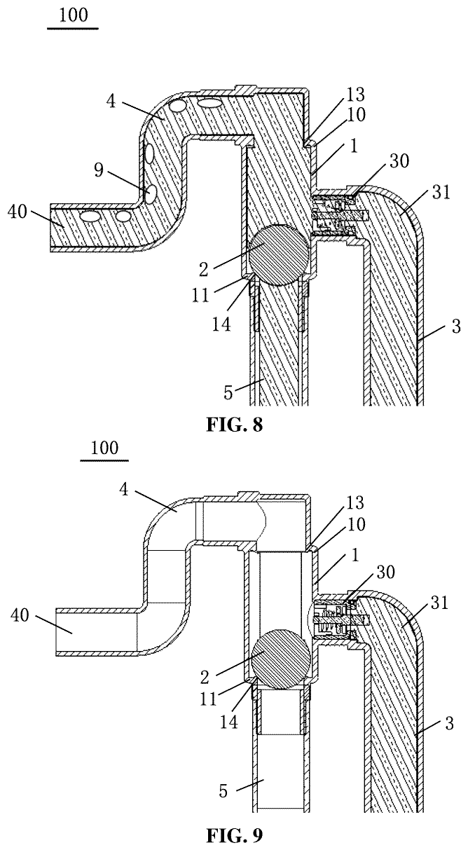

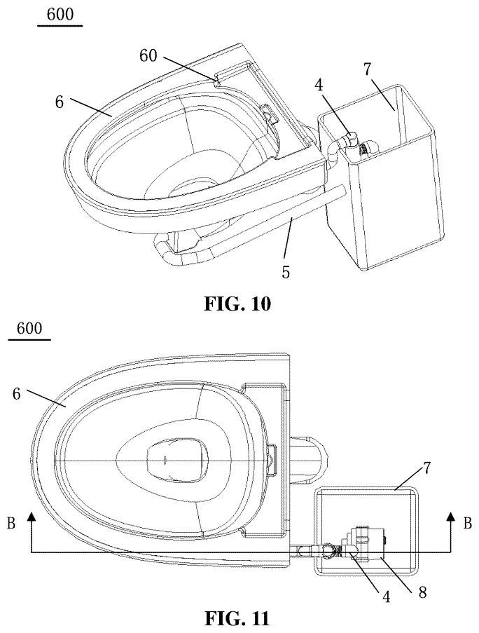

In an embodiment, the water supply time also comprises a third water supply time, the water supply stopping interval also comprises a second water supply stopping interval. The inlet pipe 3 starts supplying water to the control pipe 1 for the third time (the “third water supply”) according to the third water supply time after the second water supply stopping interval, as shown in FIGS. 7 and 8. After the inlet pipe 3 stops the third water supply, the valve core 2 is limited at the second control end 11 to restore the initial state, as shown in FIG. 9. Specifically, during the third water supply, the valve core 2 is limited to the second control end 11 by the action of its own gravitational force and the attractive force of the water flowing in the second outlet pipe 5. Thus, the water in the control pipe 1 is allowed to flow into the first outlet pipe 4. When the water supply is stopped for the third time (i.e., the third water supply is stopped) and the inertial force of the water flowing in the first outlet pipe 4 is not sufficient to overcome the attractive action, acting on the valve core 2, of the water flowing in the second outlet pipe 5, the valve core 2 is maintained in the state of abutting against the second control end 11, as shown in FIG. 9.

In an embodiment, the first control end 10 is provided with a first step 13 configured to limit the valve core 2, and the second control end 11 is provided with a second step 14 configured to limit the valve core 2. As shown in FIGS. 1-9, the first step 13, in the embodiment of the present disclosure, disposed on the first control end 10 is configured to abut against and limit the valve core 2. The second step 14 disposed on the second control end 11 is configured to abut against and limit the valve core 2. When the valve core 2 is moved to the first step 13, the side opening 12 is located below the valve core 2; and when the valve core 2 is moved to the second step 14, the side opening 12 is located above the valve core 2.

In an embodiment, there is a clearance (e.g., a gap) between the valve core 2 and the second step 14. In this present disclosure embodiment, the clearance left between the valve core 2 and the second step 14 can be used as a water drainage channel. A crevice (e.g., an opening) is provided in the second step, such that when the spherical valve core 2 abuts against the annular second step 14, the crevice and the valve core form the clearance, as shown in FIG. 2. After the second water supply is stopped, the air 9 gradually enters from a side of the first outlet pipe 4, and the air 9 passes through the water drainage channel into the second outlet pipe 5 and thus breaks the attraction, to the valve core 2, of the water flowing in the second outlet pipe 5. After the third water supply is stopped, the air 9 gradually enters from a side of the first outlet pipe 4, and the air 9 passes through the above-described water drainage channel to destroy the attraction force, to the valve core 2, of the water flowing in the second outlet pipe 5. Thus, the water gradually flows out of the second outlet pipe 5 through the water drainage channel. After a period of time, the waterway switching assembly 100 returns to its initial state as shown in FIG. 9. The above process is repeated from the first water supply in the next waterway switching.

In an embodiment, a clearance (e.g., a gap) between the valve core 2 and an inner wall of the control pipe 1 is L, wherein 0.1 mm≤L≤2 mm. Setting the clearance between 0.1 mm and 2 mm can satisfy the smooth movement of the valve core 2 in the control pipe 1 driven by the water pressure and can also avoid a large clearance between the valve core 2 and the inner wall of the control pipe 1 affecting the driving effect of the inertia force, acting on the valve core 2, of the water.

In an embodiment, the inlet pipe 3 is internally provided with a one-way control member 30 configured to allow water to flow from the inlet pipe 3 into the control pipe 1 in a single direction. The one-way control member 30 in the embodiment of the present disclosure is configured to isolate the inlet pipe 3 and the control pipe 1 and achieve the effect of unidirectionally controlling the water to flow from the inlet pipe 3 to the control pipe 1. The one-way control member 30 in the embodiment of the present disclosure may be a one-way valve or a check valve.

In an embodiment, one end of the inlet pipe 3 is provided with a connecting bend 31, the connecting bend 31 is connected to the side opening 12, the connecting bend 31 is either substantially horizontal or tilted downward in a direction toward the side opening 12, and the one-way control member 30 is provided inside the connecting bend 31. In the embodiment of the present disclosure, the connecting bend 31 provides an accommodation space for the one-way control member 30, and the connecting bend 31 is substantially horizontal or is tilted downward in a direction toward the side opening 12. This is beneficial to prevent the water from being accumulated in the connection place between the connecting bend 31 and the control pipe 1 and prevent the water from being not discharged in a timely manner.

The present disclosure also provides a toilet water supply device 600, comprising a waterway switching assembly 100 and a toilet body 6.

The toilet body 6 comprises a bowl 60, a washing outlet 61 configured to supply water to the bowl 60 and a siphon outlet 2. As shown in FIG. 1, the waterway switching assembly 100 comprises a control pipe 1, an inlet pipe 3, a first outlet pipe 4, and a second outlet pipe 5. The inlet pipe 3, the first outlet pipe 4, and the second outlet pipe 5 are in communication with (e.g., in fluid communication with) the control pipe 1. The waterway switching assembly 100 also comprises a control member (e.g., a controller 200 as described below). The control pipe 1 comprises a first control end 10 and a second control end 11, which are arranged in a length direction. The control pipe 1 comprises a side opening 12 provided between the first control end 10 and the second control end 11. The control pipe 1 is internally provided with a valve core 2 configured to move between the first control end 10 and the second control end 11.

When the valve core 2 is moved to the first control end 10, the valve core 2 and the first control end 10 are located on the same side (e.g., a first side) of the side opening 12. When the valve core 2 is moved to the second control end 11, the valve core 2 and the second control end 11 are located on the same side (e.g., a second side) of the side opening 12.

Referring to FIGS. 4 and 5, the valve core 2 and the first control end 10 are located on the same side of the side opening 12. This means that when the valve core 2 is moved to the first control end 10, the entire valve core 2 is located on a side, adjacent to the inner wall of the first control end 10, of the side opening 12, or a portion of the valve core 2 is located between the inner walls of the side opening 12. This configuration may meet the requirement that the water pressure keeps the valve core 2 abutting against the first control end 10 when the side opening 12 supplies water to the control pipe 1.

Referring to FIGS. 1, 3, 6, 7, 8, and 9, the valve core 2 and the second control end 11 are located on the same side of the side opening 12. This means that when the valve core 2 is moved to the second control end 11, the entire valve core 2 is located on a side, adjacent to the inner wall of the second control end 11, of the side opening 12, or a portion of the valve core 2 is located between the inner walls of the side opening 12. This configuration may meet the requirement that the valve core 2 is kept abutting against the second control end 11 when the side opening 12 supplies water to the control pipe 1.

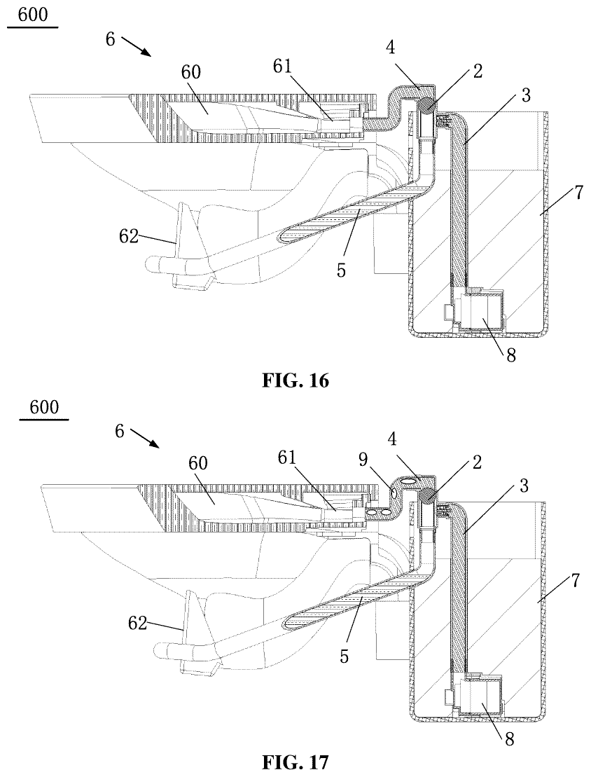

The first outlet pipe 4 is in communication with and disposed between the first control end 10 and the washing outlet 61 of the toilet body 6, and the first outlet pipe 4 comprises a first outlet 40. According to an embodiment, in an initial state, the valve core 2 is located on the same side of the side opening 12 as the second control end 11. Thus, after the inlet pipe 3 stops supplying water to the first outlet pipe 4, the valve core 2 has a tendency to move toward the first control end 10 under the action of the inertial force of the water flowing in the first outlet pipe 4. In a single flushing cycle, at the moment when the water supply from the inlet pipe 3 to the control pipe 1 is stopped for the first time (i.e., the first water supply from the inlet pipe 3 to the control pipe 1 is stopped), the water flowing in the first outlet 40 of the first outlet pipe 4 pulls the valve core 2 upward by the inertial force, and the valve core 2 overcomes its own gravitational force and is moved to the first control end 10 under the upward pulling of the inertial force, as shown in FIGS. 4 and 16.

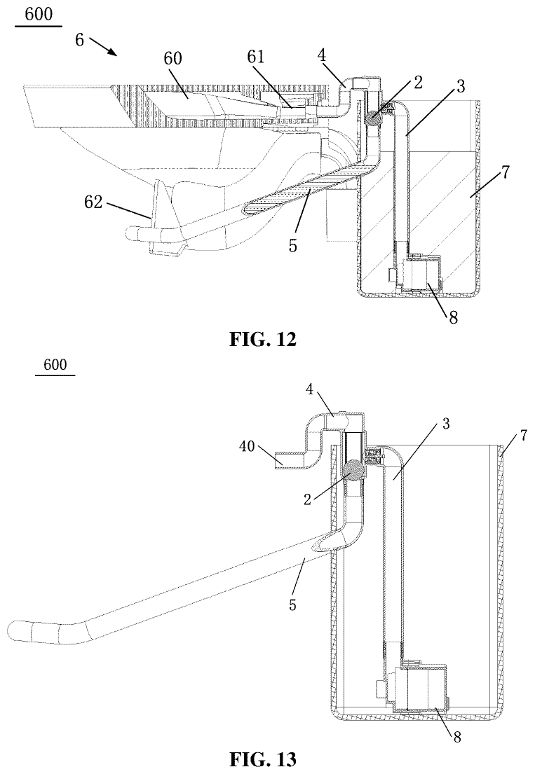

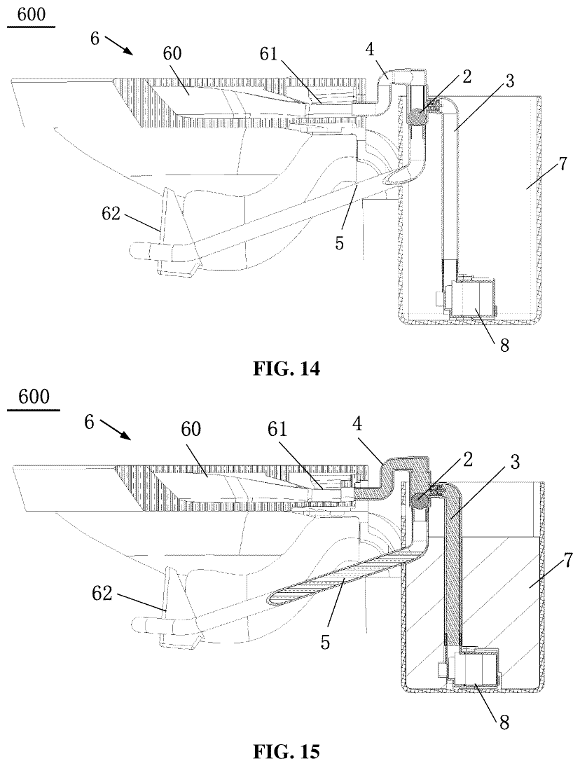

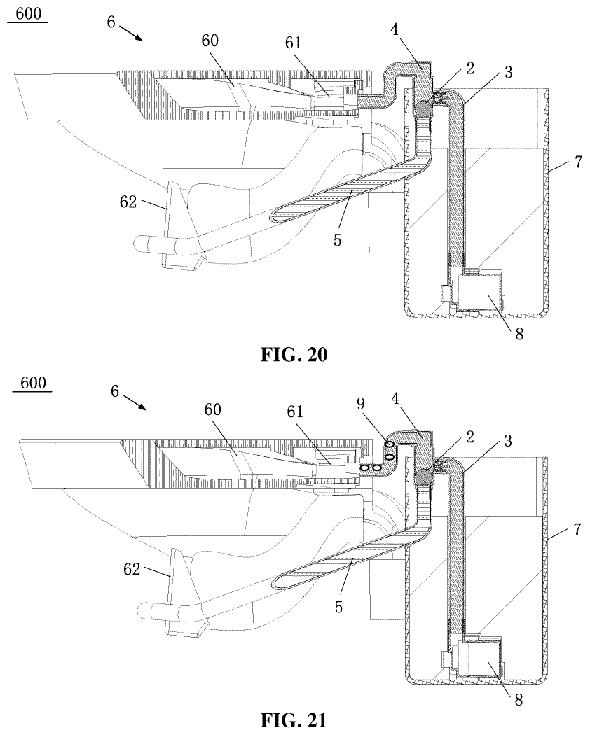

The second outlet pipe 5 is in communication with and disposed between the second control end 11 and the siphon outlet 62 of the toilet body 6, as shown in FIGS. 1-9 and 12-22.

The control member is configured to control water supply time and water supply stopping interval of the water flowing from the inlet pipe 3 into the control pipe 1 to drive the valve core 2 to move between the first control end 10 and the second control end 11 of the control pipe 1 and control the water to be discharged from the first outlet pipe 4 and the second outlet pipe 5 to flush the toilet body 6. The control member in the embodiment of the present disclosure may be a water flow switch configured to control the water supply time and water supply stopping interval of the water flowing from the inlet pipe into the control pipe. The control member in the embodiment of the present disclosure may be a control equipment (e.g., a controller 200 as described below) with preset water supply time and water supply stopping interval and configured to control the inlet pipe 3 to supply the water according to the preset water supply time and water supply stopping interval.

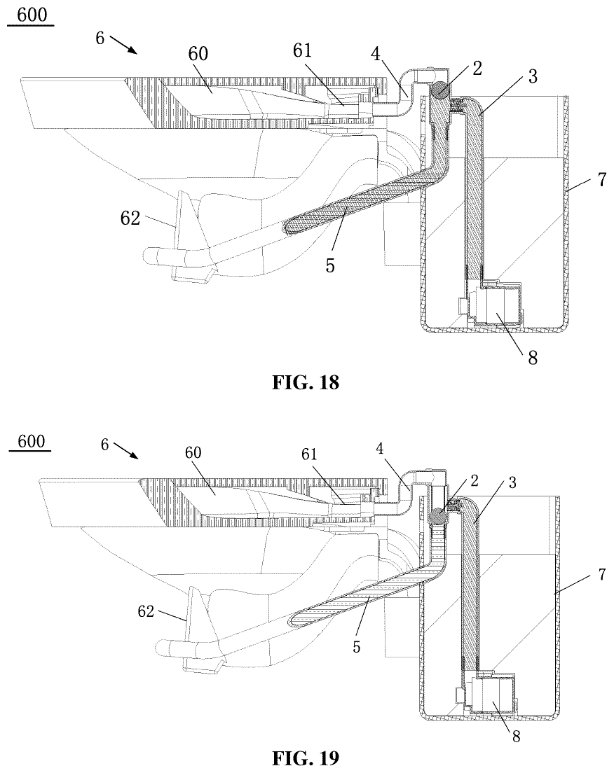

The process of flushing the toilet body 6 by the toilet water supply device 600 is described below. According to an embodiment, in an initial state, the valve core 2 is located on the same side of the side opening 12 as the second control end 11. The control member controls the inlet pipe 3 to supply water to the control pipe 1 for the first time (the “first water supply”) according to the water supply time, as shown in FIGS. 3 and 15, in order to make water come out from the first outlet 40 of the first outlet pipe 4 to the washing outlet 61 of the toilet body 6 for flushing. After the inlet pipe 3 stops supplying water for the first time (i.e., stops the first water supply), the valve core 2 is pulled upward by the inertial pulling force of the water flowing in the first outlet pipe 4 and limited at the first control end 10, as shown in FIGS. 4, 16, and 17. The inlet pipe 3 starts supplying water to the control pipe 1 for the second time (the “second water supply”) according to the water supply time after a water supply stopping interval, to limit the valve core 2 at the first control end 10 by water pressure before the valve core 2 leaves the first control end 10, so as to cause the second outlet pipe 5 to discharge water and cause siphon drainage at the siphon outlet 62, as shown in FIGS. 5 and 18. After the inlet pipe 3 stops supplying water for the second time (i.e., stops the second water supply), the valve core 2 is moved to the second control end 11 under the inertial force of the water flowing in the second outlet pipe 5. Thus, a single flush of the toilet body 6 is completed, as shown in FIGS. 6 and 19. The toilet water supply device 600 according to an embodiment in the present disclosure, by controlling the water supply time and water supply stopping interval of the water flowing in the inlet pipe 3 into the control pipe 1 via the control member, so as to achieve alternative water discharge between the first outlet pipe 4 connected to the washing outlet 61 and the second outlet pipe 5 connected to the siphon outlet 62. Thus, a single flush of the toilet body 6 is achieved. The above-mentioned flushing process is controlled by the waterway switching assembly 100, and there is no need to arrange additional components, such as a motor switching valve and a motor control member to control flushing. This may enhance the flushing effect, may reduce the cost, may simplify the design, and may save the space.

In an embodiment, the first control end 10 is located above the second control end 11. As shown in FIG. 1, in this embodiment, when in the initial state, the valve core 2 abuts against the second control end 11 under the action of water pressure. In a single waterway switching process, at the moment when the water supply from the inlet pipe 3 to the control pipe 1 is stopped for the first time, the water flowing at the first outlet 40 of the first outlet pipe 4 pulls the valve core 2 upward by the inertial force, and the valve core 2 overcomes its own gravitational force and is moved to the first control end 10 under the upward pulling of the inertial force, as shown in FIG. 4. The inlet pipe 3 starts supplying water to the control pipe 1 for the second time after a water supply stopping interval, to limit the valve core 2 at the first control end 10 by water pressure before the valve core 2 falls, so as to cause the second outlet pipe 5 to discharge water, as shown in FIGS. 5 and 18. After the inlet pipe 3 stops the second water supply, the valve core 2 is moved and abuts against the second control end 11, as shown in FIGS. 6 and 19. When the water supply is stopped for the third time, the valve core 2 is maintained against the second control end 11 by its own gravitational force.

In an embodiment, the water supply time comprises a first water supply time and a second water supply time, and the water supply stopping interval comprises a first water supply stopping interval. The inlet pipe 3 supplies water to the control pipe 1 for the first time according to the first water supply time, and the valve core 2 is limited at the second control end 11 under water pressure, so as to cause water to spray from the first outlet 40 of the first outlet pipe 4 to the bowl 60, as shown in FIGS. 3 and 15. When the inlet pipe 3 stops supplying water for the first time, the valve core 2 is pulled and moved to the first control end 10 by the inertial pulling force of water flowing in the first outlet pipe 4, and the height of the first outlet 40 is lower than the height of the first control end 10, so as to make the valve core 2 attached and maintained in the first control end 10 under the gravitational force of water flowing in the first outlet pipe 4, as shown in FIGS. 4, 16, and 17. Specifically, at the moment when the water supply from the inlet pipe 3 to the control pipe 1 is stopped for the first time, the water flowing in the first outlet 40 of the first outlet pipe 4 pulls the valve core 2 toward the position of the first control end 10 by the inertial force, and the valve core 2 is moved to the first control end 10 under the action of pulling. Also, because the height of the first outlet 40 is lower than the height of the valve core 2, the inverted U-shaped structure of the first outlet pipe 4 converts the gravitational force of the water into the suction force acting on the valve core 2 to keep the valve core 2 limited at the position of the first control end 10. The first water supply time in this embodiment may be 3 s, or the first water supply time may be selected between 2 s to 10 s to achieve a better flushing effect of the bowl 60.

The inlet pipe 3 starts supplying water to the control pipe 1 for the second time according to the second water supply time after the first water supply stopping interval, to maintain and limit the valve core 2 at the first control end 10 by water pressure before the valve core 2 falls to the first control end 10, so as to cause the first outlet pipe 5 to discharge water to achieve siphon drainage at the siphon outlet 62, as shown in FIGS. 5 and 18. After the inlet pipe 3 stops the second water supply, the valve core 2 is moved to the second control end 11, as shown in FIGS. 6 and 19. Specifically, at the moment when the water supply from the inlet pipe 3 to the control pipe 1 is stopped for the second time, the water flowing in the second outlet pipe 5 pulls the valve core 2 and limits the valve core 2 at the second control end 11 by the inertial force. The outlet of the second outlet pipe 5 is lower than the valve core 2. This configuration converts the gravitational force of the water into a suction force acting on the valve core 2 and maintains the valve core 2 in an unchanged position together with the gravitational force of the valve core 2. At the same time, the air 9 gradually enters from a side of the first outlet pipe 4, and the air 9 breaks the inertial force, acting on the valve core 2, of the water in the second outlet pipe 5. The second water supply time in this embodiment may be 4 s, or the second water supply time may be selected between 2 s to 10 s to achieve a better siphon discharge effect. The first water supply stopping interval may be 0.5 s or may be selected between 0.1 s to 1.0 s, to start the second water supply before the valve core 2 falls resulting from the air 9 gradually entering from the first outlet 40 and destroying the upward suction of the inertial force, acting on the valve core 2, of the water.

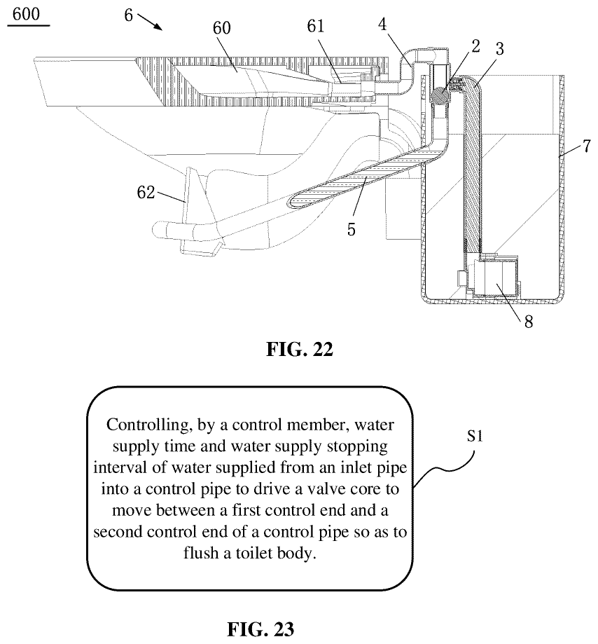

In an embodiment, the water supply time also comprises a third water supply time, the water supply stopping interval also comprises a second water supply stopping interval. The inlet pipe 3 starts supplying water to the control pipe 1 for the third time (the “third water supply”) according to the third water supply time at the second water supply stopping interval to wash the bowl 60 and form a water seal in the bowl 60, as shown in FIGS. 7, 8, 20, and 21. After the inlet pipe 3 stops the third water supply, the valve core 2 is limited at the second control end 11 to restore the initial state, as shown in FIGS. 9 and 22. Specifically, during the third water supply, the valve core 2 is limited to the second control end 11 by the action of the attractive force of the water flowing in the second outlet pipe 5. Thus, the water is allowed to flow in the control pipe 1 into the first outlet pipe 4. When the water supply is stopped for the third time (i.e., the third water supply is stopped) and the inertial force of the water flowing in the first outlet pipe 4 is not sufficient to overcome the attractive action, acting on the valve core 2, of the water flowing in the second outlet pipe 5, the valve core 2 is maintained in a state of abutting against the second control end 11. In an embodiment, the first control end 10 is provided with a first step 13 configured to limit the valve core 2, and the second control end 11 is provided with a second step 14 configured to limit the valve core 2. As shown in FIGS. 1-9, the first step 13, in the embodiment of the present disclosure, disposed on the first control end 10 is configured to abut against and limiting the valve core 2, and the second step 14 disposed on the second control end 11 is configured to abut against and limit the valve core 2. When the valve core 2 is moved to the first step 13, the side opening 12 is located below the valve core 2; and when the valve core 2 is moved to the second step 14, the side opening 12 is located above the valve core 2.

In an embodiment, there is a clearance (e.g., a gap) between the valve core 2 and the second step 14. In this present disclosure embodiment, the clearance left between the valve core 2 and the second step 14 can be used as a water drainage channel. This is achieved by providing a crevice (e.g., an opening) on the second step 14. When the spherical valve core 2 abuts against the annular second step 14, the crevice and the valve core form the clearance. After the second water supply is stopped, the air 9 gradually enters from a side of the first outlet pipe 4, and the air 9 passes through the water drainage channel into the second outlet pipe 5 and thus breaks the attraction, to the valve core 2, of the water flowing in the second outlet pipe 5. After the third water supply is stopped, the air 9 gradually enters from a side of the first outlet pipe 4, and the air 9 passes through the above-described water drainage channel to destroy the attraction force, to the valve core 2, of the water flowing in the second outlet pipe 5. Thus, the water gradually flows out of the second outlet pipe 5 through the water drainage channel. After a period of time, the waterway switching assembly 100 returns to its initial state as shown in FIGS. 9 and 22. The next time the toilet is flushed, repeat the process from the first water supply.

In an embodiment, a clearance (e.g., a gap) between the valve core 2 and an inner wall of the control pipe 1 is L, wherein 0.1 mm≤L≤2 mm. Setting the clearance between 0.1 mm and 2 mm can satisfy the smooth movement of the valve core 2 in the control pipe 1 driven by the water pressure and can also avoid a large clearance between the valve core 2 and the inner wall of the control pipe 1 affecting the driving effect of the inertia force, acting on the valve core 2, of the water.

In an embodiment, the inlet pipe 3 is internally provided with a one-way control member 30 configured to allow water to flow from the inlet pipe 3 into the control pipe 1 in a single direction. The one-way control member 30 in the embodiment of the present disclosure is configured to isolate the inlet pipe 3 and the control pipe 1 and to achieve the effect of unidirectionally controlling the water to flow from the inlet pipe 3 to the control pipe 1. The one-way control member 30 in the embodiment of this present disclosure may be a one-way valve or a check valve.

In an embodiment, one end of the inlet pipe 3 is provided with a connecting bend 31, the connecting bend 31 is connected to the side opening 12, the connecting bend 31 is either substantially horizontal or tilted downward in a direction toward the side opening 12, and the one-way control member 30 is provided inside the connecting bend 31. In the embodiment of the present disclosure, the connecting bend 31 provides an accommodation space for the one-way control member 30, and the connecting bend 31 is substantially horizontal or is tilted downward in a direction toward the side opening 12. This is beneficial to prevent the water from being accumulated in the connection place between the connecting bend 31 and the control pipe 1 and prevent the water from being not discharged in a timely manner.

In an embodiment, when flushing water is supplied to the control pipe 1, the flushing water is stored in a water tank 7, a water pump 8 is provided in the water tank 7, and the control member (e.g., the controller 200 as described below) is communicably connected to the water pump 8 and configured to control the water supply time and the water supply stopping interval by controlling on-and-off of the water pump 8 (turning on or turning off the water pump 8). The control member is communicably connected to the water pump 8 to control on-and-off of the water pump 8 according to the preset water supply time and water supply stopping interval. Thus, the first water supply time, the second water supply time, the third water supply time, the first water supply stopping interval, and the second water supply stopping interval of the inlet pipe 3 may be controlled. In the embodiment of the present disclosure, the water tank 7 or the toilet body 6 is provided with an on-and off switch, and the on-and off switch is pressed to control the control member to start working.

In an embodiment, when the water is supplied to the control pipe 1, the washing water is pressurized water, and the pressurized water may come from tap water with water pressure. A control switch 32 is provided on the inlet pipe 3 or on a water supply component for the pressurized water, the control member (e.g., the controller 200 as described below) is communicably connected to the control switch 32 to control the water supply time and the water supply stopping interval by controlling on-and-off of the controller switch. The control switch 32 in the embodiment of the present disclosure may be an electromagnetic switch, and the control member controls on-and-off of the electromagnetic switch. Thus, the first water supply time, the second water supply time, the third water supply time, and the first water supply stopping interval, and the second water supply stopping interval of the inlet pipe 3 may be controlled. In the embodiment of the present disclosure, the water tank 7 or the toilet body 6 is provided with an on-and off switch, and the on-and off switch is pressed to control the control member to start working.

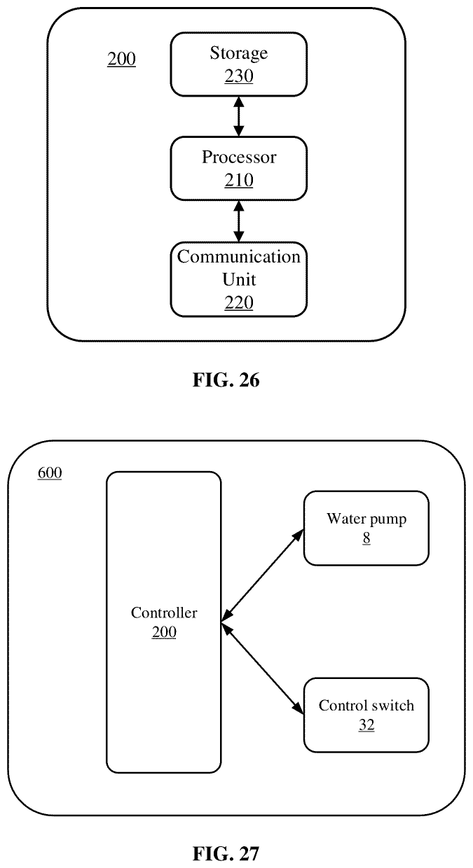

FIG. 26 is a block diagram of a controller of the toilet water supply device according to an embodiment of the present disclosure. FIG. 27 is a block diagram of the toilet water supply device comprising the controller according to an embodiment of the present disclosure.

As shown in FIG. 26, a controller 200 comprises a processor 210, a communication unit 220 communicably connected to the processor 210, and a storage 230 communicably connected to the processor 210.

The controller 200 in the present disclosure can be implemented by any appliances or by any software or applications run by the appliances. The controller 200 may be connected to a workstation or another external device (e.g., control panel, remote) and/or a database for receiving user inputs, system characteristics, and any of the values described herein. Optionally, the controller 200 may include an input device and/or a sensing circuit in communication with any of the sensors. The sensing circuit receives sensor measurements from as described above. Optionally, the controller 200 may include a drive unit for receiving and reading non-transitory computer media having instructions. Additional, different, or fewer components may be included.

The processor 210 is configured to perform instructions stored in memory for executing the algorithms described herein. The processor 210 may be a general purpose or specific purpose processor, an application specific integrated circuit (ASIC), one or more programmable logic controllers (PLCs), one or more field programmable gate arrays (FPGAs), a group of processing components, or other suitable processing components. The processor 210 is configured to execute computer code or instructions stored in memory or received from other computer readable media (e.g., embedded flash memory, local hard disk storage, local ROM, network storage, a remote server, etc.). The processor 210 may be a single device or combinations of devices, such as associated with a network, distributed processing, or cloud computing.

The communication unit 220 may include any operable connection, ingress ports, and egress ports. An operable connection may be one in which signals, physical communications, and/or logical communications may be sent and/or received. An operable connection may include a physical interface, an electrical interface, and/or a data interface. The communication unit 220 may be connected to a network. The network may include wired networks (e.g., Ethernet), wireless networks, or combinations thereof. The wireless network may be a cellular telephone network, an 802.11, 802.16, 802.20, or WiMax network, a Bluetooth pairing of devices, or a Bluetooth mesh network. Further, the network may be a public network, such as the Internet, a private network, such as an intranet, or combinations thereof, and may utilize a variety of networking protocols now available or later developed including, but not limited to TCP/IP based networking protocols.

In an embodiment, the storage 230 may include one or more devices (e.g., memory units, memory devices, storage devices, etc.) for storing data and/or computer code for completing and/or facilitating the various processes described in the present disclosure. The storage 230 may include random access memory (RAM), read-only memory (ROM), hard drive storage, temporary storage, non-volatile memory, flash memory, optical memory, or any other suitable memory for storing software objects and/or computer instructions. The storage 230 may include database components, object code components, script components, or any other type of information structure for supporting the various activities and information structures described in the present disclosure. The storage 230 may be communicably connected to processor via a processing circuit and may include computer code for executing (e.g., by processor) one or more processes described herein. For example, the storage 230 may include graphics, web pages, HTML files, XML files, script code, shower configuration files, or other resources for use in generating graphical user interfaces for display and/or for use in interpreting user interface inputs to make command, control, or communication decisions.

In an embodiment, the toilet in the above embodiments may include a base (e.g., a pedestal, a bowl, etc.) and a tank. The base is configured to be attached to another object such as a drainpipe, floor, or another suitable object. The base includes a bowl, a sump (e.g., a receptacle) disposed below the bowl, and a trapway fluidly connecting the bowl to a drainpipe or sewage line. The tank may be supported by the base, such as an upper surface of a rim. The tank may be integrally formed with the base as a single unitary body. In other embodiments, the tank may be formed separately from the base and coupled (e.g., attached, secured, fastened, connected, etc.) to the base. The toilet may further include a tank lid covering an opening and inner cavity in the tank. The toilet may include a seat assembly including a seat and a seat cover rotatably coupled to the base. The toilet arrangement may further include a hinge assembly.

In another embodiment, the toilet arrangement may be a tankless toilet. The toilet arrangement includes a base and a seat assembly coupled to the base. The base includes a bowl, a sump disposed below the bowl, and a trapway fluidly connecting the bowl to a drainpipe or sewage line. The toilet arrangement includes a waterline that supplies the toilet with water. The toilet may further include a seat assembly including a seat and a seat cover rotatably coupled to the base. The toilets described above are provided herein as non-limiting examples of toilets that may be configured to utilize aspects of the present disclosure.

In some examples, a bidet may be included in a seat or pedestal of a toilet. In other examples, the bidet may be manufactured separately from and attached or coupled to a seat or pedestal of a toilet. The bidet includes a housing. The housing is configured to receive a flow of water through a housing inlet and dispense the flow of water from a housing outlet. The housing inlet and housing outlet may be located on opposite ends of the housing from one another, such that water may flow through the housing from the housing inlet to the housing outlet. In some examples, the housing further includes a chamber. As the housing receives the flow of water, the chamber may fill with water and provide a flow of water between the housing inlet and the housing outlet. The chamber may be configured to contain the flow of water and direct the flow of water from the housing inlet to the housing outlet. After the chamber has filled with water, the flow of water may travel along a substantially linear path between the housing inlet and the housing outlet. In some examples, one or more walls within the housing may be included to help direct a flow of water between the housing inlet and the housing outlet. The bidet may further include a housing inlet conduit configured to direct a flow of water to the housing inlet. The housing inlet conduit may be coupled to a water supply such as tank or waterline. The housing may further include a gear assembly or a portion of the gear assembly. The bidet may be a front wash bidet for female users and may use, generate, and/perform the functions related to nanobubbles, ozonated water, eWater, hydrogen peroxide generation, pH Control, template assisted crystallization, application of polyphosphates, filtration (ultrafiltration, nanofiltration, microfiltration, carbon/GAC), fluidic oscillating sprays, and adding other consumables in the water stream. For nanobubbles, air, ozone, oxygen, hydrogen, and carbon dioxide may be used.

An embodiment of the present disclosure further provides a method for supplying detergent diluted solution to a water-using device by using a detergent sustained-release device. FIG. 21 is a flow chart of a method for supplying detergent diluted solution to a water-using device by using a detergent sustained-release device according to an embodiment of the present disclosure. Here, the method uses the detergent sustained-release device according to any of the embodiments of the present disclosure. The water-using device in the method may be the water-using device of the water-using apparatus according to any of the embodiments of the present disclosure. The descriptions regarding the detergent sustained-release device, the water-using device, and the water-using apparatus as described in the present disclosure are incorporated herein. The detergent sustained-release device, the water-using device, and the water-using apparatus are configured to perform an operation, function, or the like as described in the present disclosure.

The present disclosure also provides a flushing method for controlling a toilet water supply device 600 to flush water according to the embodiments described above, as shown in FIG. 23. The toilet water supply device in the method may be the toilet water supply device 600 according to any of the embodiments of the present disclosure. The descriptions regarding the toilet water supply device as described in the present disclosure are incorporated herein. The toilet water supply device is configured to perform an operation, function, or the like as described in the present disclosure. The method comprises the following steps.

S1: the control member (e.g., the controller 200) controls water supply time and water supply stopping interval of the water flowing from the inlet pipe 3 to the control pipe 1 to drive the valve core 2 to move between the first control end 10 and the second control end 11 of the control pipe 1 to flush the toilet body 6.

In this step, the control member controls the inlet pipe 3 to supply water to the control pipe 1 for the first time (the “first water supply”) according to the water supply time, and the valve core 2 is limited at the second control end 11 under water pressure, as shown in FIGS. 1 and 15. Thus, the first outlet 40 of the first outlet pipe 4 discharges water to the washing outlet 61 of the toilet body 6 for flushing. After the inlet pipe 3 stops supplying water for the first time (i.e., stops the first water supply), the valve core 2 is pulled upward by the inertial pulling force of the water flowing in the first outlet pipe 4 and limited at the first control end 10, as shown in FIGS. 4, 16, and 17. The inlet pipe 3 starts supplying water to the control pipe 1 for the second time (the “second water supply”) according to the water supply time after a water supply stopping interval, to limit the valve core 2 at the first control end 10 by water pressure before the valve core 2 falls. Thus, the second outlet pipe 5 discharges water to achieve siphon drainage at the siphon outlet 62, as shown in FIGS. 5 and 18. After the inlet pipe 3 stops the second water supply (i.e., stops the second water supply), the valve core 2 is moved to the second control end 11, a single flush of the toilet body 6 is completed, as shown in FIGS. 6 and 19.

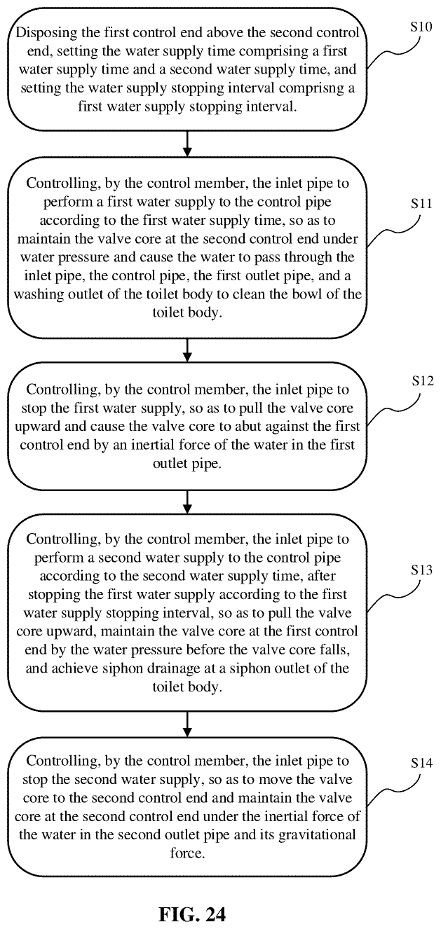

In an embodiment, as shown in FIG. 24, the method further comprises the following steps in order to complete a single flush of the toilet body 6.

S10: the first control end 10 is disposed above the second control end 11, the water supply time comprises a first water supply time and a second water supply time, and the water supply stopping interval comprises a first water supply stopping interval.

S11: in the initial state, the valve core 2 is disposed on the same side of the side opening 12 as the second control end 11, the control member controls the inlet pipe 3 to supply water to the control pipe 1 for the first time (the “first water supply”) according to the first water supply time, and the valve core 2 is limited at the second control end 11 under water pressure. The flushing water passes through the inlet pipe 3, the control pipe 1, and the first outlet pipe 4 and then flows out of the washing outlet 61 of the toilet body 6 to clean the bowl 60 of the toilet body 6, as shown in FIGS. 3 and 15.

S12: the control member controls the inlet pipe 3 to stop supplying water for the first time (i.e., stops the first water supply), the valve core 2 is pulled upward and limited at the first control end 10 by the inertial pulling force of the water flowing in the first outlet pipe 4, as shown in FIGS. 4, 16, and 17. Specifically, at the moment when the water supply from the inlet pipe 3 to the control pipe 1 stops for the first time, the water flowing in the first outlet 40 of the first outlet pipe 4 pulls the valve core 2 by the inertial force, and the valve core 2 abuts against the first control end 10 under the action of pulling. Thus, because the height of the first outlet 40 is lower than that of the valve core 2, the inverted U-shaped structure of the first outlet pipe 4 converts the gravitational force of the water into the suction force acting on the valve core 2 to maintain and limit the valve core 2 at an unchanged position at the first control end 10. The first water supply time in this embodiment may be 3 s, or the first water supply time may be selected between 2 s to 10 s to achieve a better flushing effect on the bowl 60.

S13: the control member controls the inlet pipe 3 to supply water to the control pipe 1 for the second time (the “second water supply”) according to the second water supply time, after stopping water supply according to the first water supply stopping interval, to pull the valve core 2 upward and limit the valve core 2 at the first control end 10 by water pressure before the valve core 2 falls. Thus, the second outlet pipe 5 discharges water to achieve siphon drainage at the siphon outlet 62 of the toilet body 6. Specifically, at the moment when the water supply from the inlet pipe 3 to the control pipe 1 stops for the second time, the water flowing in the second outlet pipe 5 pulls the valve core 2 downward and limits the valve core 2 at the second control end 11 by the inertial force. The outlet of the second outlet pipe 5 is lower than the valve core 2. This configuration converts the gravitational force of the water into a suction force acting on the valve core 2 and maintains the valve core 2 in a constant position together with the gravitational force of the valve core 2. At the same time, the air 9 gradually enters from a side of the first outlet pipe 4, and the air 9 breaks the inertial force, acting on the valve core 2, of the water in the second outlet pipe 5. The second water supply time in this embodiment may be 4 s, or the second water supply time may be selected between 2 s to 10 s to achieve a better siphon discharge effect. The first water supply stopping interval may be 0.5 s or may be selected between 0.1 s to 1.0 s, to start the second water supply before the valve core 2 falls resulting from the air 9 gradually entering from the first outlet 40 and destroying the upward suction of the inertial force, acting on the valve core 2, of the water.

S14: the control member controls the inlet pipe 3 to stop the second water supply (i.e., stops the second water supply), and the valve core 2 is moved to the second control end 11 under the inertial force of the water flowing in the second outlet pipe 5 and its own gravitational force.

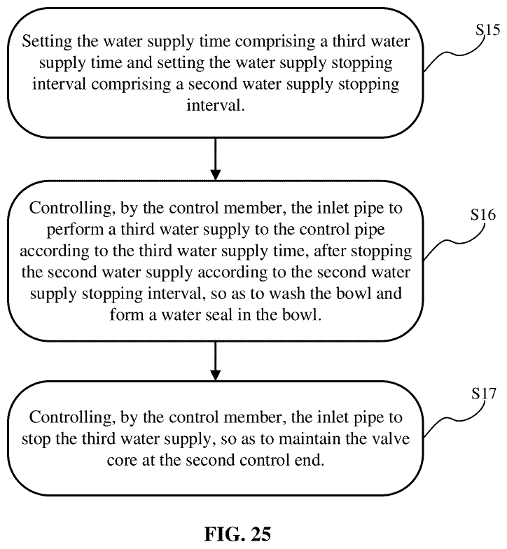

In an embodiment, as shown in FIG. 25, the method further comprises the following steps.

S15: the water supply time further comprises a third water supply time, and the water supply stopping interval further comprises a second water supply stopping interval.

S16: the control member controls the inlet pipe 3 to supply water to the control pipe 1 for the third time (the “third water supply”) according to the third water supply time after stopping water according to the second water supply stopping interval, to wash the bowl 60 and form a water seal in the bowl 60, as shown in FIGS. 7, 8, 20, and 21.

S17: the control member controls the inlet pipe 3 to stop supplying water for the third time (i.e., stops the third water supply), and the valve core 2 is limited at the second control end 11 to restore the initial state, as shown in FIGS. 9 and 22. Specifically, during the third water supply, the valve core 2 is limited to the second control end 11 by the action of its own gravitational force and the attractive force of the water flowing in the second outlet pipe 5 to allow the water to flow in the control pipe 1 into the first outlet pipe 4. When the water supply is stopped for the third time and the inertial force of the water flowing in the first outlet pipe 4 is not sufficient to overcome the attractive force of the water flowing in the second outlet pipe 5 to the valve core 2 and the gravitational force of the valve core 2 itself, the valve core 2 maintains the state of being limited at the second control end 11.

The above technical solutions may be combined, if necessary, to achieve the best technical effect.

The above are merely the principle and the preferred embodiments of the present disclosure. It should be pointed out that, for those having ordinary skill in the art, several other modifications may be made on the basis of the principle of the present disclosure, which should also be regarded as falling in the protection scope of the present disclosure.

1-22. (canceled)

23. A waterway switching assembly, comprising:
a control pipe comprising:
a first control end;
a second control end; and
a side opening disposed between the first control end and the second control end;
a valve core disposed in the control pipe and configured to move between the first control end and the second control end;
a first outlet pipe in fluid communication with the first control end; and
a second outlet pipe in fluid communication with the second control end.

24. The waterway switching assembly according to claim 23, wherein when the valve core is moved to the first control end, the valve core and the first control end are disposed on a first side of the side opening, and the second outlet pipe discharges water, and
wherein when the valve core is moved to the second control end, the valve core and the second control end are disposed on a second side of the side opening, and the first outlet pipe discharges the water.

25. The waterway switching assembly according to claim 24, further comprising:
an inlet pipe in fluid communication with the control pipe,
wherein the first control end is disposed above the second control end.

26. The waterway switching assembly according to claim 25, wherein the valve core is configured to be maintained at the second control end so as to cause the first outlet pipe to discharge water, in response to a water pressure during a first water supply from the inlet pipe to the control pipe,
wherein the valve core is configured to be moved to the first control end, in response to an inertial force of the water in the first outlet pipe after the first water supply from the inlet pipe to the control pipe is completed,
wherein the valve core is configured to be maintained at the first control end so as to cause the second outlet pipe to discharge the water, in response to the water pressure during a second water supply from the inlet pipe to the control pipe, and
wherein the valve core is configured to be moved to the second control end in response to an inertial force of the water in the second outlet pipe and a gravitational force of the valve core after the second water supply from the inlet pipe to the control pipe is completed.

27. The waterway switching assembly according to claim 25, further comprising:
a one-way control member disposed in the inlet pipe and configured to allow the water to flow from the inlet pipe into the control pipe in a single direction.

28. The waterway switching assembly according to claim 27, wherein the inlet pipe comprises:
a connecting bend disposed at an end of the inlet pipe and connected to the side opening,
wherein the connecting bend is substantially horizontal or tilted downward in a direction toward the side opening, and
wherein the one-way control member is disposed inside the connecting bend.

29. The waterway switching assembly according to claim 23, wherein a height of an outlet of the first outlet pipe is lower than a height of the first control end.

30. The waterway switching assembly according to claim 23, further comprising:
a first step disposed at the first control end and configured to limit the valve core; and
a second step disposed at the second control end and configured to limit the valve core.

31. The waterway switching assembly according to claim 30, further comprising:
a gap formed between the valve core and the second step and configured to allow air coming from the first outlet pipe to enter the second outlet pipe.

32. The waterway switching assembly according to claim 23, further comprising:
a gap between the valve core and an inner wall of the control pipe,
wherein the gap between the valve core and the inner wall of the control pipe is L, and
wherein 0.1 mm≤L≤2 mm.

33. A toilet water supply device, comprising:
a toilet body comprising:
a bowl;
a washing outlet configured to supply water to the bowl; and
a siphon outlet configured to cause siphon drainage;
a waterway switching assembly comprising:
a control pipe comprising a first control end and a second control end;
a valve core disposed in the control pipe and configured to move between the first control end and the second control end;
a first outlet pipe in fluid communication with and disposed between the first control end and the washing outlet; and
a second outlet pipe in fluid communication with and disposed between the second control end and the siphon outlet.

34. The toilet water supply device according to claim 33, further comprising:
a side opening disposed between the first control end and the second control end,
wherein when the valve core is moved to the first control end, the valve core and the first control end are disposed on a first side of the side opening, and the second outlet pipe discharges water, and
wherein when the valve core is moved to the second control end, the valve core and the second control end are disposed on a second side of the side opening, and the first outlet pipe discharges water.

35. The toilet water supply device according to claim 33, further comprising:
an inlet pipe in fluid communication with the control pipe,
wherein the first control end is disposed above the second control end.

36. The waterway switching assembly according to claim 35, wherein the valve core is configured to be maintained at the second control end so as to cause the first outlet pipe to discharge water, in response to a water pressure during a first water supply from the inlet pipe to the control pipe,
wherein the valve core is configured to be moved to the first control end, in response to an inertial force of the water in the first outlet pipe after the first water supply from the inlet pipe to the control pipe is completed,
wherein the valve core is configured to be maintained at the first control end so as to cause the second outlet pipe to discharge the water, in response to the water pressure during a second water supply from the inlet pipe to the control pipe, and
wherein the valve core is configured to be moved to the second control end in response to an inertial force of the water in the second outlet pipe and a gravitational force of the valve core after the second water supply from the inlet pipe to the control pipe is completed.

37. The toilet water supply device according to claim 36, further comprising:
a controller configured to control water supply time and water supply stopping interval of the water supplied from the inlet pipe into the control pipe.

38. The toilet water supply device according to claim 37, wherein the water supply time comprises a first water supply time and a second water supply time,
wherein the water supply stopping interval comprises a first water supply stopping interval, and
wherein the controller is further configured to:
control the inlet pipe to perform the first water supply according to the first water supply time, so as to cause the first outlet pipe to discharge the water to flush the bowl;
control the inlet pipe to stop performing the first water supply according to the first water supply stopping interval, so as to move the valve core to the first control end;
control the inlet pipe to perform the second water supply according to the second water supply time after the first water supply stopping interval, so as to maintain the valve core at the first control end, cause the second outlet pipe to discharge the water, and cause the siphon drainage at the siphon outlet; and
control the inlet pipe to stop performing the second water supply, so as to cause the valve core to move to the second control end.

39. The toilet water supply device according to claim 38, wherein the water supply time further comprises a third water supply time,
wherein the water supply stopping interval further comprises a second water supply stopping interval, and
wherein the controller is further configured to:
control the inlet pipe to perform a third supply water according to the third water supply time after the second water supply stopping interval, so as to wash the bowl and form a water seal in the bowl; and
control the inlet pipe to stop performing the third water supply, so as to maintain the valve core at the second control end.

40. The toilet water supply device according to claim 37, further comprising:
a water pump communicably connected to the controller; or
a control switch communicably connected to the controller,
wherein the controller is further configured to control the water supply time and the water supply stopping interval by turning on or turning off the water pump or the control switch.

41. A flushing method for controlling a toilet water supply device, the method comprising:
controlling, by a controller, water supply time and water supply stopping interval of water supplied from an inlet pipe of the toilet water supply device to a control pipe of the toilet water supply device so as to drive a valve core of the toilet water supply device to move between a first control end of the control pipe and a second control end of the control pipe.

42. The flushing method for controlling the toilet water supply device according to claim 41, wherein controlling, by the controller, the water supply time and the water supply stopping interval comprises:
controlling, by a controller, the inlet pipe to perform a first water supply according to a first water supply time, so as to cause a first outlet pipe of the toilet water supply device to discharge the water to flush a bowl;
controlling, by the controller, the inlet pipe to stop performing the first water supply according to a first water supply stopping interval, so as to move the valve core to the first control end;
controlling, by the controller, the inlet pipe to perform a second water supply according to a second water supply time after the first water supply stopping interval, so as to maintain the valve core at the first control end, cause a second outlet pipe of the toilet water supply device to discharge the water, and cause siphon drainage at a siphon outlet;
controlling, by the controller, the inlet pipe to stop performing the second water supply according to a second water supply stopping interval, so as to cause the valve core to move to the second control end;
controlling, by the controller, the inlet pipe to perform a third supply water according to a third water supply time after the second water supply stopping interval, so as to form a water seal in the bowl; and
controlling, by the controller, the inlet pipe to stop performing the third water supply, so as to maintain the valve core at the second control end.
